(19) United States
(12) Patent Application Publication
(10) Pub. No.: US 2011/0219335 A1
(43) Pub. Date: Sep. 8, 2011

(54) Accommodating Very Large Fonts on Memory-Constrained Electronic Devices

(76) Inventor: John P. Powers, Garland, TX (US)

(21) Appl. No.: 13/027,253

(22) Filed: Feb. 14, 2011

Related U.S. Application Data
(60) Provisional application No. 61/311,680, filed on Mar. 8, 2010.

(51) Int. Cl. G06T 11/00; G06F 3/048

(52) U.S. Cl. 715/810; 345/472

(57) ABSTRACT

Accommodation of large fonts on a memory-constrained electronic device is provided by storing a first set of font bitmaps on the electronic device in various faces, styles and sizes and storing a second set of font bitmaps in one size and style. When a command is received to display text corresponding to a string of character numbers, parameters are also provided for face, style, and size. For each character number in the string of character numbers, a font bitmap is selected corresponding to the character number. When the character number is within a first set of values, a font bitmap is selected from the first set of font bitmaps according to the specified size and style parameters. When the character number is within another set of values, the style and font parameters are ignored and a font bitmap is selected from the second set of font bitmaps.

### CROSS-REFERENCE TO RELATED APPLICATIONS

This application claims benefit of U.S. Provisional Patent Application Ser. No. 61/311,680, filed Mar. 8, 2010, entitled “Method and Apparatus for Accommodating Very Large Fonts on Memory-Constrained Electronic Devices” which is incorporated herein by reference in its entirety.

### BACKGROUND OF THE INVENTION

Handheld calculators are well known in the art and have been in use for many years. Although many handheld calculators are limited to simple algebraic computations such as addition, subtraction, multiplication, and division, there are several commercially available handheld calculators that are able to perform higher level mathematical computations. For example, some handheld calculators allow a user to input a plurality of quadratic equations into the handheld calculator. The handheld calculator may then graph each of the equations on a coordinate plane and determine the intersection of the lines or curves created by the equations. The handheld calculator may also solve the quadratic equations algebraically. The same handheld calculator can also allow a user to enter a higher order and/or multi-variable equation into the handheld calculator and provide values for some of the variables. The handheld calculator can then solve for the remaining variables. Handheld calculators that perform these functions are manufactured by numerous companies including Texas Instruments.

Handheld calculators may support a large number of languages and display various text items, such as menus, in a language selected by a user.

### BRIEF DESCRIPTION OF THE DRAWINGS

Particular embodiments in accordance with the invention will now be described, by way of example, and with reference to the accompanying drawings:

FIG. 1 shows an example of a calculator in accordance with one or more embodiments of the invention;

FIG. 2 is a block diagram of a calculator in accordance with one or more embodiments of the invention;

FIG. 3 illustrates mapping of character numbers to various font bitmaps;

FIG. 4 illustrates placement of font bitmaps in the memory of the calculator of FIG. 1; and

FIG. 5 is a flow diagram illustrating font bitmap selection by a font rendering engine.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency. In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Embodiments of the present invention are discussed below with respect to an embodiment on a handheld calculator. It should be noted, however, that embodiments of the present invention may be useful for other types of electronic devices, e.g., laptop computers, desktop computers, handheld computing devices. Examples of other types of handheld computing devices in which embodiments of the present invention may be useful include scientific calculators, advanced calculators able to upload and run software applications, handheld-sized limited-purpose computer devices, handheld-sized educational computer devices, handheld-sized portable computer devices, portable computer devices, personal digital assistants (PDA), palmtop computers, cellular or mobile telephones, and any combination thereof.

Handheld calculators have progressed to be very sophisticated processing systems. A handheld calculator, such as the TI-Nspire™ from Texas Instruments, is capable of operating on one or more documents. In one version of such a calculator, each document may be divided into at least one, and up to thirty, problems. Each problem contains at least one, and up to fifty, pages. Each page can be divided into as many as four work areas. Each work area can contain any of the TI-Nspire™ applications: Calculator, Graph, Geometry, Lists & Spreadsheet, Data & Statistics and Notes.

In one embodiment of the invention, an application may be selected from a Home Menu by clicking one of the following application icons: Calculator—this is a static application; Graph; Geometry; Lists & Spreadsheet; Data & Statistics; Notes—this is a text editor with math boxes that provides a dynamic computing environment. In this embodiment, up to four applications may be open on each page. When a user creates a new document it contains space to add one application. If the user wishes to add more than one application to a page, the user can change the layout to accommodate as many as four applications.

A math box is simply a term that is used to describe an area in the display screen that holds a math expression that has in input expression, an output expression and a separator symbol. The input and output expressions may both include numbers and/or symbols. The symbol separator may be any of the typical math operations, such as: =, =>, <=, or even “NONE”. For example: a+b=14. If the separator symbol is “NONE”, then three spaces, for example, are displayed between the input expression and the output expression; for example: a+b 14. A typical math problem may include just a few or a large number of math boxes.

During a typical problem solving session, in addition to symbols in text boxes, various menus and text information may be displayed on the calculator. The fonts in an exemplary hand-held TI-Nspire calculator may occupy 395 KB of RAM to hold thirty-four different sets of bit maps for Latin fonts. Chinese characters are now being added to the fonts in order to support product offerings in Chinese-speaking markets. If multiple sets of Chinese characters to mirror the thirty-four Latin font sets are added, the fonts would occupy over 22 MB of RAM. This leaves insufficient memory for other functionality in the hand-held TI-Nspire, which is a 32 MB device. In order to introduce Chinese characters into TI-Nspire without consuming too much memory, just one font containing Chinese characters is added. The routines which draw or measure text on the hand-held device check each character before being drawn on the display. If the character falls outside the range of Chinese characters, drawing proceeds as usual with font face, style, and size chosen by the application software. If, however, the character number falls within the range of Chinese characters, the Chinese font is substituted and the font face, style and size parameters specified by the application are ignored. This reduces the total memory required for the mix of Latin and Chinese fonts to approximately 1070 KB.

Implementing multiple fonts for Latin characters but just a single font for Chinese characters allows an application to retain the versatility of formatting non-Chinese text in a variety of font faces, styles, and sizes. This approach saves a large amount of memory in a memory-constrained platform and minimizes impact on text drawing performance.

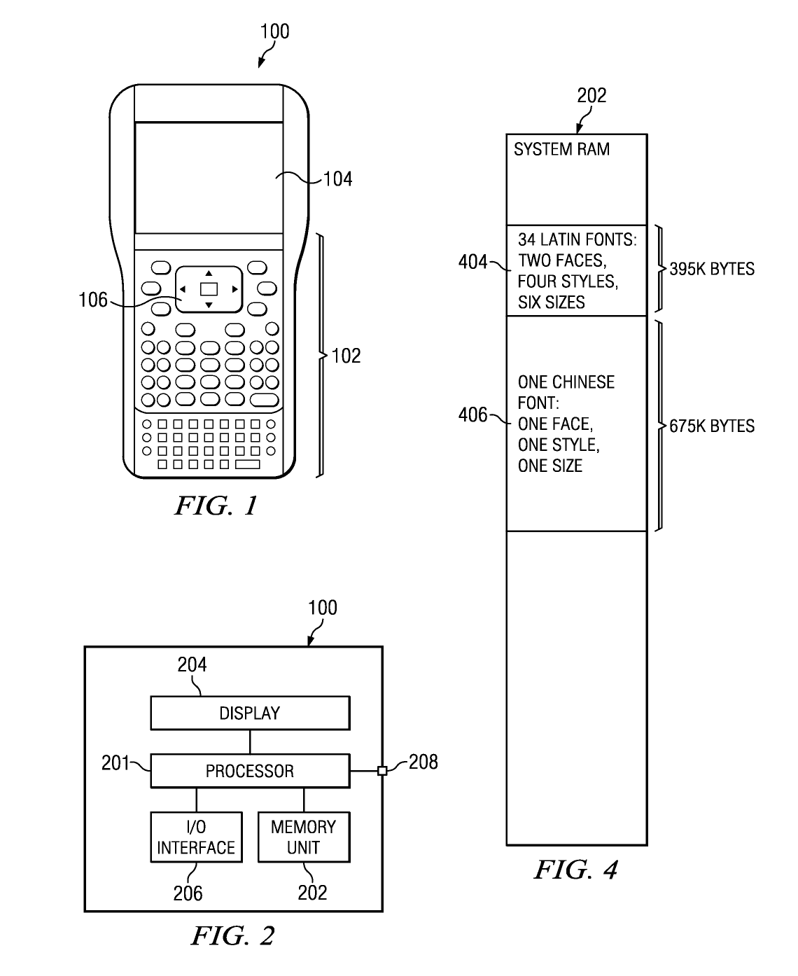

FIG. 1 shows an example of a handheld calculator 100 in accordance with one or more embodiments of the invention. For illustrative purposes, the handheld calculator illustrated in FIG. 1 is similar to graphing calculators available from Texas Instruments Inc. Handheld calculators with more or fewer components may be used in other embodiments of the invention. As shown in FIG. 1, the handheld calculator 100 includes a graphical display 104, and a keypad 102 that includes a touchpad 106. The graphical display 104 may be used to display, among other things, information input to applications executing on the handheld calculator 100 and various outputs of the applications. The graphical display 104 may be, for example, an LCD display. The keypad 102 allows a user, e.g., a student or instructor, to enter data and functions and to start and interact with applications executing on the handheld calculator 100. The keypad 102 also includes an alphabetic keyboard for entering text. The touchpad 106 allows a user to interact with the display 104 by translating the motion and position of the user's fingers on the touchpad 106 to provide functionality similar to using an external pointing device, e.g., a mouse. A user may use the touchpad 106 to perform operations similar to using a pointing device on a computer system, e.g., scrolling the display 104 content, pointer positioning, selecting, highlighting, etc.

FIG. 2 is a block diagram of the handheld calculator 100 in accordance with one or more embodiments of the invention. The handheld calculator 100 includes a processor 201 coupled to a memory unit 202, which may include one or both of read-only memory (ROM) and random-access memory (RAM). In some embodiments of the invention, the ROM stores software programs and font bitmaps and the RAM stores intermediate data and operating results. An input/output port 208 provides connectivity to external devices, e.g., a hub that is coupled to other handheld calculators and/or a classroom computer. The input/output port 208 may be a bi-directional connection such as a mini-A USB port. Also included in the handheld calculator 100 are a display 204 and an I/O interface 206. The I/O interface 206 provides an interface to couple input devices such as the touchpad 106 and the keypad 102 to the processor 201. In some embodiments of the invention, the handheld calculator 100 may also include an integrated wireless interface (not shown) or a port for connecting an external wireless interface (not shown).

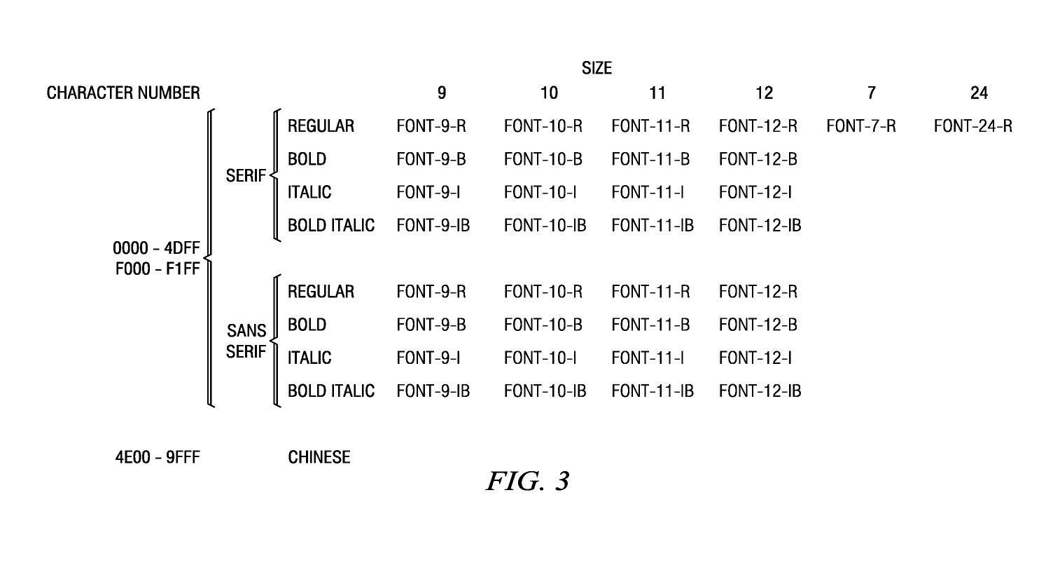

FIG. 3 illustrates mapping of character numbers to various font bitmaps. All fonts for calculator 100 are pre-rendered bitmaps. These fonts consist of combinations of face families (serif and sans serif), styles (regular, bold, italic, and bold italic), and sizes (9, 10, 11, and 12) plus a very small font (7 pt) and a very large font (24 pt), amounting to thirty-four bitmaps. These bitmaps consume approximately 395K bytes of RAM. The addition of thousands of Chinese characters to all thirty-four bitmaps would grow the memory requirement by megabytes.

In this embodiment, the Chinese character set is rendered in just one size, large enough (at least 12 px high by 11 px wide) so characters are clearly distinguishable. The memory for this single font takes approximately 675K of RAM.

FIG. 4 illustrates placement of font bitmaps in memory 202 of calculator 100 of FIG. 1. Total memory consumption for the existing Latin font bitmaps 404 plus the Chinese font bitmap 406 comes to approximately 1070K bytes.

The single Chinese font 406 includes two locals: Simplified Chinese and Traditional Chinese. Simplified Chinese is targeted to mainland China. Traditional Chinese is favored in Hong Kong and Taiwan. The language/country code for mainland China is “zh_CN” and consists of simplified Chinese ( [symbol] ) characters in the font and collation tables. The language/country code for Taiwan is “zh_TW” and consists of traditional Chinese ( [symbol] ) characters in the font and collation tables. Hong Kong has a separate country code (“HK”) but is not represented internally by a separate locale since it shares the traditional Chinese characters and collation tables with Taiwan. The language picker in the hand-held settings allows the user to choose between simplified Chinese or traditional Chinese with no mention of country.

The Chinese fonts include the Unicode CJK Unified Ideographs block (U+4E00-U+9FFF) plus symbols needed by the Chinese symbol input method editor (IME) (some in the U+30XX and U+FFxx blocks). This block comprises 20,902 common ideographs that supports simplified and traditional Chinese characters, and also provides support for Korean and other Asian languages.

Characters in CJK Unified Ideographs Extensions A and B are rarely used. Furthermore, Extension B requires supporting characters wider than 16 bits, thereby doubling the memory requirement for all strings and is not supported by the font rendering engine in calculator 100.

A subset of the Unicode CJK block consisting of 15,448 characters is used on calculator 100. These characters are a Unicode blend of the character sets specified in GB2312 for Simplified Chinese and Big5 for Traditional Chinese, Chinese punctuation (30XX) and full width punctuation (FFXX). CJK is a collective term for “Chinese, Japanese and Korean.” GB2312 is the registered internet name for a key official character set of the People's Republic of China, used for simplified Chinese characters. Other embodiments of the current invention may use different subsets, rather than the same 15,448 characters used in calculator 100.

Calculator 100 has two input method editors, Pinyin and Zhuyin. The IME is invoked when the flag key on keyboard 102 is pressed. When simplified Chinese is in effect and the flag key is pressed, the Pinyin IME is invoked. When traditional Chinese is in effect, the Zhuyin IME is invoked. Some additional characters in the 2000 range are needed to support the Chinese symbols IME. All the additional characters that are included in the Chinese bitmap font to assist in the IME for calculator 100 are listed in Table 1.

TABLE 1
Chinese characters for IME

| Codepoint | Symbol | | Codepoint | Symbol | |
|---|---|---|---|---|---|
| | | | FF01 | ! | Full-width |
| | | | | | Characters |
| 2030 | ‰ | | FF03 | # | |
| 203B | | | FF04 | $ | |
| 2237 | :: | | FF05 | % | |
| 223D | ~ | | FF06 | & | |
| 224C | [symbol] | | FF0A | * | |
| 25A0 | ▪ | | FF0B | + | |
| 25CF | | | FF0C | , | |
| 3001 | [symbol] | Chinese | FF0D | − | |
| | | Punctuation | | | |
| 3002 | ° | | FF0F | / | |
| 300A | [symbol] | | FF1A | : | |
| 300B | [symbol] | | FF1B | ; | |
| 300E | [symbol] | | FF1D | = | |
| 300F | [symbol] | | FF1F | ? | |
| 3010 | [symbol] | | FF20 | @ | |
| 3011 | [symbol] | | FF3C | \ | |
| | | | FF3F | _{—} | |
| | | | FF5C | \| | |
| | | | FF5E | ~ | |
| | | | FFE1 | £ | |
| | | | FFE5 | ¥ | |

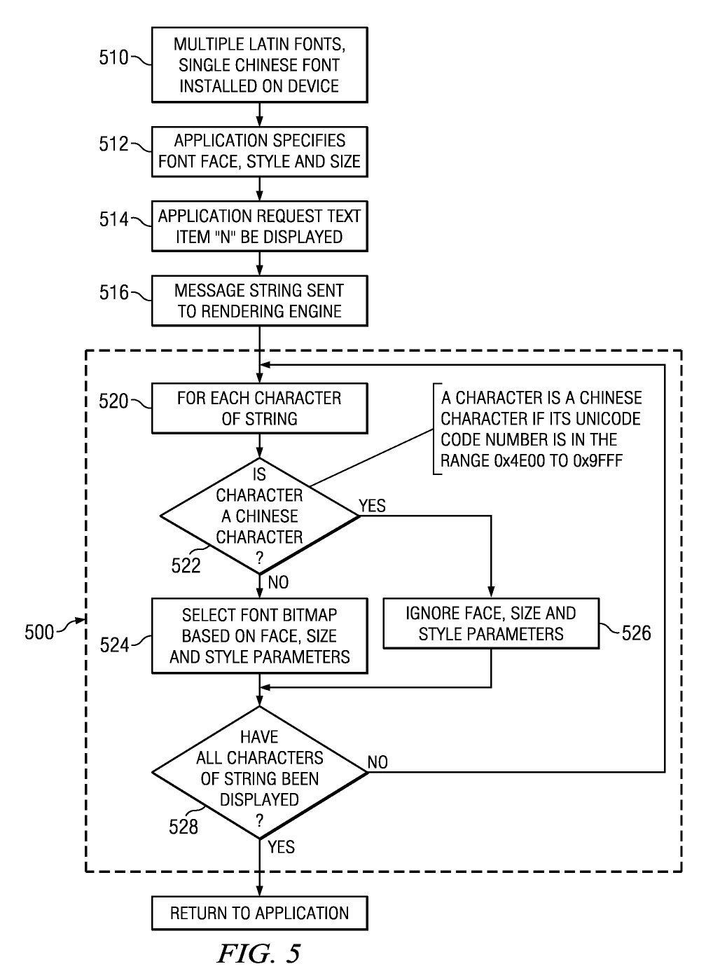

FIG. 5 is a flow diagram illustrating font bitmap selection by a font rendering engine 500 in calculator 100. When a string containing a mix of Latin and Chinese characters needs to be displayed, the font rendering engine must switch to the single Chinese font bitmap when it encounters a Chinese character, or display the character using the previously set font face, style, and size for non-Chinese characters.

As described in more detail above, multiple Latin fonts and a single Chinese font are installed 510 on calculator 100. The multiple Latin fonts may include different faces, such as serif, sans-serif, or various styles such as Times Roman, Arial, etc. The multiple fonts may also include, in addition to the regular font, italic, bold and/or italic-bold styles in various sizes, such as 9, 10, 11, and 12 points, for example. This is typically done at the time of manufacture of calculator 100, but in some situations fonts may be downloaded onto the device in response to user interaction.

When an application is executed on device 100, the application typically specifies 512 the font face, style and size to be used for menus, messages and other text displayed by the application. Font specifications may be performed once for the entire application, or may be specified by reference to a set of parameters each time a call is made to the rendering engine to display a text item.

On device 100, all of the text items are pre-composed and numbered. Each message is translated into character strings for each of the multiple languages that are supported by device 100. The message strings are all stored in a string library in the memory of device 100. The language to be used for a particular session may be selected by a user, or it may be set as a default value that is invoked each time the device is turned on, for example.

As the application executes, it may reach a point where a menu, message or other text item is due to be displayed. At this point, the application calls 514 the string library using the number of the desired text item. A message string is selected from the string library that corresponds to the requested message number and to the active language and is then sent 516 to the font rendering engine. For example, if the text item is “enter file name” and has been assigned an item number, such as “123”, when the application makes a call to the string library with the value “123”, the string library will return a string of character numbers corresponding to “enter file name” if the device is operating in English mode. If the device is operating in Spanish mode, for example, then the string library may return a string of character numbers corresponding to “introducir el nombre de archive.” Similarly, if the device is operating in Chinese mode, the string library will return a string of character numbers corresponding to a Chinese phrase that has a similar meaning.

Rendering engine 500 receives the character string and the parameters that specify the face, style and size to be used when rendering the text item. For each character number 520 in the string of character numbers, a font bitmap corresponding to the character number is selected from the font bitmap library. When 522 the character number is within a first set of values, such as 0x0000-0x4DFF and 0xF000-0xF1 FF, a font bitmap is selected 524 from the Latin set of font bitmaps according to the specified size and style parameters. When the character number is within a second specified set of values, such as 0x4E00-0x9FFF, the style and font parameters are ignored and a font bitmap is selected 526 from the Chinese set of font bitmaps. This is repeated 528 for each character number in the string.

Chinese words do not have spaces between them. The word wrapping mechanism of text boxes wraps between Chinese characters, such it does not truncate characters beyond the width of the text box. Menus containing Chinese characters are sized to not overlap menus above or below. There is no small font for Chinese characters—in this embodiment they are implemented in one size. The bounding box of text items that specify a small font is expanded when they include Chinese characters. Text boxes which include Chinese characters adjust their height so they do not crop those characters

An application may allow the user to change the style of characters to bold or italic. As described above, Chinese characters are embodied in one style on calculator 100. In a mix of Latin and Chinese characters, the Latin characters will reflect the user's style setting but Chinese characters will remain unchanged.

In this manner, device 100 can support multiple languages, with multiple font faces, styles and sizes for the simple Latin type letters/symbols and also support a large pictograph type font set for Oriental languages while using a relatively small amount of memory to store the total set of font bitmaps.

### Other Embodiments

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims. It is therefore contemplated that the appended claims will cover any such modifications of the embodiments as fall within the true scope and spirit of the invention.

Embodiments of the present invention were described with respect to an embodiment on a handheld calculator. As mentioned above, however, embodiments of the present invention may be useful for other types of electronic devices, e.g., laptop computers, desktop computers, handheld computing devices. Examples of other types of handheld computing devices in which embodiments of the present invention may be useful include scientific calculators, advanced calculators able to upload and run software applications, handheld-sized limited-purpose computer devices, handheld-sized educational computer devices, handheld-sized portable computer devices, portable computer devices, personal digital assistants (PDA), palmtop computers, cellular or mobile telephones, and any combination thereof.

For example, in a cell phone, various applications may be configured to call a font rendering engine included within the cell phone that renders fonts for both Latin and Oriental fonts, for example, as described herein using bit mapped fonts stored on the cell phone.

In other embodiments, fonts families other than Latin may be used, for example, Greek and Cyrillic alphabets, Hebrew, Arabic, dingbats, etc. In other embodiments, other or additional pictograph symbols may be used to support Japanese, Korean, etc., languages.

In other embodiments, there may be more than one version of the Chinese fonts. For example, there may be two of more sizes in a device with more available memory space, or there may be a partial additional set of Chinese fonts in a different size. In this example, the face and style font parameters are ignored, and the size parameter is mapped to one of the available two or more sizes by the rendering engine when the Chinese font is rendered.

Another embodiment of the invention may be in a printing device. In this case, fonts may be rendered for printing on a fixed media as described herein. Therefore, in the claims the term “display” includes displaying on a display device, displaying on a projection device, displaying on fixed media using printing technology, etc.

A teacher may use an interactive instruction system, e.g., a handheld calculator connected to a computer system and a display device such as a digital projector and screen or interactive whiteboard, in a classroom to replicate the display of the handheld calculator in real time in a larger format on the display device for viewing by students, i.e., for presenting digital instruction to the students. More specifically, the teacher can perform operations using the handheld calculator and allow the students to view the results of the operations in real-time in the larger format provided by the display device. A teacher may also record a video from a sequence of operations performed on the handheld calculator, e.g., a lesson, in a file and play the recorded video to present it on the display device. Additional description of the operation of the TI-Nspire calculator is provided in the “TI-Nspire Teacher Software Guidebook” for software version 2.1, July 2010, which is incorporated by reference herein. The computer system may render various sets of fonts for different languages as described herein. Alternatively, the computer system may render fonts using more memory intensive approaches such as by using TrueType fonts which require significantly more memory than is available on device 100 for holding fonts. In this case, the handheld devices used by students in the classroom will still render fonts as described herein.

The techniques described in this disclosure may be implemented in hardware, software, firmware, or any combination thereof. If implemented in software, the software may be executed in one or more processors, such as a microprocessor, application specific integrated circuit (ASIC), field programmable gate array (FPGA), or digital signal processor (DSP). The software that executes the techniques may be initially stored in a computer-readable medium such as compact disc (CD), a diskette, a tape, a file, memory, or any other computer readable storage device and loaded and executed in the processor. In some cases, the software may also be sold in a computer program product, which includes the computer-readable medium and packaging materials for the computer-readable medium. In some cases, the software instructions may be distributed via removable computer readable media (e.g., floppy disk, optical disk, flash memory, USB key), via a transmission path from computer readable media on another digital system, etc.

Certain terms are used throughout the following description and the claims to refer to particular system components. As one skilled in the art will appreciate, components of computer and handheld calculator systems may be referred to by different names and/or may be combined in ways not shown herein without departing from the described functionality. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” and derivatives thereof are intended to mean an indirect, direct, optical, and/or wireless connection. Thus, if a first device couples to a second device, that connection may be through a direct connection, through an indirect connection via other devices and connections, through an optical connection, and/or through a wireless connection.

Although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein.

What is claimed is:

1. A method for accommodating large fonts on a memory-constrained electronic device, the method comprising:
receiving parameters that specify a font size and style to use for displaying text;
receiving a command to display a string of text, wherein the command includes a string of character numbers; and
selecting, for each character number in the string of character numbers, a font bitmap corresponding to the character number, wherein when the character number is within a first set of values, a font bitmap is selected from a first set of font bitmaps according to the specified size and style parameters; and wherein when the character number is within a second set of values, the font parameters are ignored and a font bitmap is selected from a second set of font bitmaps.

2. The method of claim 1, further comprising:
storing a first set of font bitmaps on the electronic device, wherein the first set of font bitmaps comprises a plurality of sizes and styles;
storing a second set of font bitmaps on the electronic device, wherein the second set of font bitmaps has one size and style.

3. The method of claim 1, wherein the first set of font bitmaps comprise Latin characters and the second set of font bitmaps comprise Chinese symbols.

4. The method of claim 1, wherein the electronic device is a hand-held calculator.

5. An electronic device, comprising:
a user interface having a display and an input device; and
a processor coupled to the user interface and to memory, wherein the processor is configured to execute program instructions stored in the memory to render fonts from sets of font bitmaps stored in the memory, wherein the program instructions are configured to:
receive parameters that specify a font size and style to use for displaying text on the display;
receive a command to display a string of text, wherein the command includes a string of character numbers; and
select, for each character number in the string of character numbers, a font bitmap corresponding to the character number, wherein when the character number is within a first set of values, a font bitmap is selected from the first set of font bitmaps according to the specified size and style parameters; and wherein when the character number is within a second set of values, the font parameters are ignored and a font bitmap is selected from the second set of font bitmaps.

6. The electronic device of claim 5, wherein the first set of font bitmaps comprise Latin characters and the second set of font bitmaps comprise Chinese symbols.

7. The electronic device of claim 5, being a hand-held calculator.

8. The electronic device of claim 5, being a cellular telephone.

9. A computer readable medium comprising instructions executable by a processor in a device to perform a method comprising:
receiving parameters that specify a font size and style to use for displaying text;
receiving a command to display a string of text, wherein the command includes a string of character numbers; and
selecting, for each character number in the string of character numbers, a font bitmap corresponding to the character number, wherein when the character number is within a first set of values, a font bitmap is selected from a first set of font bitmaps according to the specified size and style parameters; and wherein when the character number is within a second set of values, the font parameters are ignored and a font bitmap is selected from a second set of font bitmaps.

10. The method of claim 9, wherein the first set of font bitmaps comprises a plurality of sizes and styles, and the second set of font bitmaps has one size and style.

11. The method of claim 9, wherein the first set of font bitmaps comprise Latin characters and the second set of font bitmaps comprise Chinese symbols.

12. The method of claim 9, wherein the device is a handheld calculator.
